(19) United States
(12) Patent Application Publication
(10) Pub. No.: US 2026/0217609 A1
(43) Pub. Date: Jul. 30, 2026

(54) LTCC COMPOSITION HAVING IMPROVED PROPERTIES, MANUFACTURING METHOD OF CERAMIC ELECTRIC ELEMENT USING THE SAME AND CERAMIC ELECTRIC ELEMENT THEREFROM

(71) Applicant: Korea Institute of Ceramic Engineering and Technology, Jinju-si (KR)

(72) Inventors: Sang Soo CHEE, Jinju-si (KR); Hyo Soon SHIN, Jinju-si (KR); Seung Hyup LEE, Jeonju-si (KR); Hyun Tae KIM, Jinju-si (KR); Yong Geun CHOI, Jinju-si (KR); Ji Hui LEE, Jinju-si (KR); Gyeong Ho YUN, Gyeongsan-si (KR); Sang Jun PARK, Jinju-si (KR); Seung Hee KIM, Jinju-si (KR)

(21) Appl. No.: 19/630,109

(22) Filed: Mar. 26, 2026

(30) Foreign Application Priority Data
Oct. 23, 2025 (KR) 10-2025-0154317

(51) Int. Cl. C04B 35/14; C03C 14/00; C04B 35/64; C04B 41/00; C04B 41/45; C04B 41/51; H01B 3/12

(52) U.S. Cl. CPC C04B 35/14; C03C 14/004; C04B 35/64; C04B 41/0072; C04B 41/4578; C04B 41/51; H01B 3/12; C03C 2214/04; C04B 2235/3418; C04B 2235/365; C04B 2235/386; C04B 2235/5436; C04B 2235/6025; C04B 2235/9607

(57) ABSTRACT

Provided are an LTCC composition having an improved property, a manufacturing method of a ceramic electric element using the same and a ceramic electric element therefrom. The LTCC composition according to the present disclosure includes: a frit including silica and alumina; a first filler including at least any one of silica and alumina; and a second filler including hexagonal boron nitride and having a granular shape.

### CROSS REFERENCE TO RELATED APPLICATION

This application claims the benefit of Korean Patent Application No. 10-2025-0154317, filed on October 23, 2025, the contents of which are all hereby incorporated by reference herein in their entirety

### TECHNICAL FIELD

The present disclosure relates to a LTCC composition having an improved properties, a manufacturing method of a ceramic electric element using the same and a ceramic electric element therefrom.

### BACKGROUND

With the rapid rise of next-generation smart systems such as AI robots, drones, autonomous vehicles, or the like, there is an essential need to develop 6G communication technology that can connect the next-generation smart systems at high speed and high reliability.

6G communication requires signal transmission that is 10 times faster or more and smoother than that of existing 5G, and to achieve this, there has emerged as a key issue ensuring the performance of communication components and substrate materials that can stably operate even in ultra-high frequency bands such as millimeter wave and Sub-THz.

However, in such frequency bands, transmission loss, electromagnetic interference, heat dissipation, and the like occur simultaneously, degrading the long-term reliability of materials. Therefore, it is essential to develop high-performance substrate materials to address these issues.

Low Temperature Co-Fired Ceramics (LTCC) substrate material is one of the representative communication substrate materials. The dielectric constant can be controlled according to a composition, and it is widely used as a communication substrate material due to its low dielectric loss, excellent thermal dissipation, and low-temperature process characteristics.

In addition, it is very suitable as a substrate material for 6G communication modules that require micropattern formation and lamination of dozens of layers or more. However, in the ultra-high frequency region of Ka-/E-band or higher required for 6G communication, performance limitations of existing materials are clearly revealed, such as increased signal loss, electromagnetic interference, reliability degradation due to complex structures, and heat dissipation limitations. Therefore, it is necessary to develop new materials to solve these problems.

### Prior Art Document

### Patent Documents

Korean Patent Registration No. 10-1651744 (issued on August 29, 2016)

Korean Patent Registration No. 10-2716712 (issued on October 11, 2024)

Korean Patent Unexamined Publication No. 2023-0151430 (published on November 1, 2023)

U.S. Patent No. 5593526 (issued on January 14, 1997)

### SUMMARY

Accordingly, the present disclosure provides an LTCC composition having an improved property, a manufacturing method of a ceramic electric element using the same and a ceramic electric element therefrom.

In an aspect, provided is an LTCC composition which includes: a frit including silica and alumina; a first filler including at least any one of silica and alumina; and a second filler including hexagonal boron nitride and having a granular shape.

The first filler may include silica, and the first filler content may be 100 to 140 parts by weight and the second filler content may be 15 to 30 parts by weight, with respect to 100 parts by weight of the frit.

The first filler may include silica, and the first filler content may be 110 to 130 parts by weight, and the second filler content may be 18 to 25 parts by weight, with respect to 100 parts by weight of the frit.

A sintering temperature of the LTCC composition may be 650 to 950°C.

The LTCC composition may have a dielectric constant of 3.75 to 4.05, a strength of 235 to 265 MPa, and a thermal conductivity of 1.3 to 2.1 W/mK at 15 GHz after sintering.

A particle size distribution of the second filler may be 1 to 10 μm, and D50 may be 2 to 4 μm.

The second filler may further include amorphous boron nitride, and an intensity ratio of I₍₀₀₂₎/I₍₁₀₀₎ of the second filler may be 2 to 7 in an XRD graph.

The alumina content in the frit may be 30 to 40 wt%.

The frit may further include calcium oxide and boron trioxide, and with respect to 100 parts by weight of the silica, the alumina content may be 65 to 90 parts by weight, the calcium oxide content may be 15 to 30 parts by weight, and the boron trioxide content may be 15 to 30 parts by weight.

In another aspect, provided is a manufacturing method of a ceramic electric element using low-temperature co-sintering, which includes: forming a green tape from a slurry of an LTCC composition; disposing a metal electrode on at least one surface of the green tape; and co-sintering the green tape and the metal electrode at 650 to 950°C, in which the LTCC composition includes a frit including silica and alumina; a first filler including at least one of silica and alumina; and a second filler including hexagonal boron nitride and having a granular shape.

The first filler may include silica, and the first filler content may be 100 to 140 parts by weight and the second filler content may be 15 to 30 parts by weight, with respect to 100 parts by weight of the frit.

The LTCC composition may have a dielectric constant of 3.75 to 4.05, a strength of 235 to 265 MPa, and a thermal conductivity of 1.3 to 2.1 W/mK at 15 GHz after sintering.

A particle size distribution of the second filler may be 1 to 10 μm, and D50 may be 2 to 4 μm.

The alumina content in the frit may be 30 to 40 wt%.

In yet another aspect, provided is a ceramic electric element obtained through low-temperature co-sintering, which includes: a ceramic substrate; and a metal electrode formed on at least one surface of the ceramic substrate, in which the ceramic substrate includes a BN filler that includes hexagonal boron nitride and has a granular shape.

The BN filler content may be 5 to 13 wt% in the ceramic substrate.

The ceramic substrate may have a dielectric constant of 3.75 to 4.05, a strength of 235 to 265 MPa, and a thermal conductivity of 1.3 to 2.1 W/mK at 15 GHz.

A particle size distribution of the BN filler may be 1 to 10 μm, and D50 may be 2 to 4 μm.

The BN filler may further include amorphous boron nitride, and an intensity ratio of I₍₀₀₂₎/I₍₁₀₀₎ of the BN filler may be 2 to 7 in an XRD graph.

A crystalline phase of the ceramic substrate may contain 80 to 100 wt% of an anorthite phase, and the ceramic substrate and the metal electrode may be obtained by co-sintering at 650 to 950°C.

According to the present disclosure, there are provided an LTCC composition having an improved property, a manufacturing method of a ceramic electric element using the same and a ceramic electric element therefrom.

### BRIEF DESCRIPTION OF THE DRAWINGS

FIG. 1 is a schematic diagram of a ceramic substrate manufactured according to an embodiment of the present disclosure;

FIG. 2 is an XRD graph when a first filler accounts for 30 vol % in Example 1;

FIG. 3 is an SEM image when the first filler accounts for 30 vol % in Example 1;

FIGS. 4, 5, and FIG. 6 illustrate results of evaluating a dielectric constant (15 GHz), strength, and thermal conductivity while changing a volume ratio in Example 1;

FIGS. 7, 8, and FIG. 9 illustrate results of evaluating a dielectric constant (15 GHz), strength, and thermal conductivity while changing a volume ratio in Comparative Example 1;

FIG. 10 illustrates a result of measuring a dielectric constant while changing a volume ratio of a frit to alumina in Comparative Example 2;

FIGS. 11 and 12 are an SEM image and an XRD graph of hBN in Example 2;

FIG. 13 is an SEM image when 10 vol % of hBN is used in Example 2;

FIGS. 14, 15, and FIG. 16 illustrate results of evaluating a dielectric constant (15 GHz), strength, and thermal conductivity while changing a use amount of hBN in Example 2;

FIGS. 17, 18, and FIG. 19 illustrate results of evaluating a dielectric constant (15 GHz), strength, and thermal conductivity while changing a use amount of planar hBN in Comparative Example 3;

### Comparative Examples 3;

FIG. 20 is an XRD graph after sintering a frit and a first filler (silica) when 50 vol % of the first filler is used in Example 3;

FIG. 21 is an SEM image when the volume ratio of the first filler to the frit is approximately 50:50 and 10 vol % of granular h-BN is used in Example 3;

FIGS. 22, 23, and FIG. 24 illustrate results of evaluating a dielectric constant (15 GHz), strength, and thermal conductivity while fixing the use amount of hBN to 10 vol % and changing a use amount of the first filler in Example 3;

FIG. 25 illustrates an XRD graph of a second filler according to a heat treatment temperature in Example 4;

FIGS. 26, 27 and 28 illustrate changes in dielectric constant, strength and thermal conductivity according to an intensity ratio of I₍₀₀₂₎/I₍₁₀₀₎ in an XRD graph in Example 5; and

FIGS. 29, 30 and 31 illustrate changes in dielectric constant, strength and thermal conductivity according to a heat treatment temperature in a second filler manufacturing process in Example 5.

### DETAILED DESCRIPTION

Hereinafter, reference will be made to the accompanying drawings to describe various embodiments of the present disclosure in detail so that those skilled in the art can easily implement the present disclosure. The present disclosure may be implemented in various different forms and is not limited to embodiments described herein.

Parts irrelevant to the description will be omitted to clearly describe the present disclosure, and the same elements will be designated by the same reference numerals throughout the specification.

In addition, since the size and thickness of each configuration illustrated in the drawings are arbitrarily shown for ease of description, the present disclosure is not necessarily limited thereto.

Existing low dielectric/low loss LTCC materials have been successful in securing certain levels of characteristics through various glass phase combinations and filler enhancements, but there is no development example of a material that simultaneously satisfies high strength and high thermal dissipation performance even while maintaining low dielectric constant and low loss characteristics.

In particular, simultaneous implementation of these multiple characteristics is essential in an ultra-high frequency band of 6G communication, so the development of new materials that can overcome the limitations of existing LTCC technology is required. Accordingly, the development of a low-dielectric high-strength material based on anorthite-based crystalline glass is proposed as an alternative.

Anorthite among LTCC glass crystallines is an aluminosilicate crystalline phase, and according to a mechanism in which nucleation occurs from a surface of an LTCC alumina filler and grows during sintering, finally, the alumina filler is partially melted during a liquid phase sintering process.

When an anorthite phase is manufactured, the anorthite phase has superior chemical resistance and strength to other crystalline structure phases (diopside, cordierite, etc.), but has a disadvantage of a high dielectric constant of approximately 6 to 7.

That is, since an alumina filler with a high dielectric constant is fundamentally used, mechanical strength may be ensured, but there is a disadvantage that the high dielectric constant of alumina increases the dielectric constant of the entire composition. This may lead to problems such as transmission delay and reflection loss in ultra-high frequency communication.

In the present disclosure, an anorthite phase is manufactured by applying a SiO₂ filler with a low dielectric constant instead of using the alumina filler. In this case, when an Al₂O₃ content in a glass composition is increased further compared to an existing content to form the anorthite phase, high strength may be achieved together with a low dielectric property.

Additionally, by spheroidizing a hexagonal boron nitride (h-BN) filler that exhibits high thermal conductivity characteristics, anisotropic thermal conductivity characteristics are suppressed, thereby improving thermal conductivity reliability of overall LTCC composite properties and solving a heat generation problem occurring at an ultra-high frequency.

The LTCC composition according to the present disclosure includes a frit, a first filler, and a second filler.

The frit may include silica (SiO₂) and alumina (Al₂O₃), and may further include calcium oxide (CaO) and boron trioxide (B₂O₃). In addition, the frit may further include MgO or Li₂O.

The frit according to the present disclosure has a higher alumina content than conventional frits. The alumina content in the frit according to the present disclosure may be 25 to 45 wt%, 30 to 40 wt%, or 33 to 37 wt%. When MgO is included, the MgO content may be 2 to 10 wt% or 3 to 7 wt%.

With respect to 100 parts by weight of silica, the alumina content may be 65 to 90 parts by weight or 70 to 85 parts by weight, the calcium oxide content may be 15 to 30 parts by weight or 18 to 26 parts by weight, and the boron trioxide content may be 15 to 30 parts by weight or 18 to 30 parts by weight.

The frit is obtained by melting frit raw materials such as silica and alumina at 1200 to °C.1600

The first filler (silica filler) includes silica. The first filler may include, in addition to silica, minor amounts of other components. The silica content in the first filler may be 90 to 100 wt%, 95 to 100 wt%, or 99 to 100 wt%. The first filler may substantially consist of 100 wt% silica.

The second filler (BN filler) may include hexagonal boron nitride (hBN) and may further include amorphous boron nitride (aBN). The content of the hexagonal boron nitride (hBN) may be 70 to 100 wt%, 80 to 100 wt%, 90 to 100 wt%, or 99 to 100 wt%. The second filler may also substantially consist of 100 wt% of hexagonal boron nitrides (hBN).

The content of the second filler in the LTCC composition may be 5 to 13 wt% or 7 to 11 wt%.

When the second filler includes the hexagonal boron nitride (hBN) and the amorphous boron nitride (aBN), the intensity ratio of I₍₀₀₂₎/I₍₁₀₀₎ in the XRD graph of the second filler may be 1.5 to 10, from 2 to 5, or 2.5 to 4.0.

The second filler may be granular. The term “granular shape” in the present disclosure is a concept distinct from planar and fibrous shapes and includes a spherical shape. The granular shape in the present disclosure may exhibit various shapes with an aspect ratio (long axis/short axis) of 1 to 3, 1 to 1.5, or 1 to 1.2.

A particle size distribution of the second filler may be 0.5 to 20 μm or 1 to 10 μm. D50 of the second filler may be 2 to 4 μm or 2.5 to 3.5 μm, and an average particle diameter may also be 2 to 4 μm or 2.5 to 3.5 μm.

With respect to 100 parts by weight of the frit, the first filler may be included in an amount of 80 to 160 parts by weight, 100 to 140 parts by weight, or 110 to 130 parts by weight, and the second filler may be included in an amount of 10 to 35 parts by weight, 15 to 30 parts by weight, or 18 to 25 parts by weight.

The LTCC composition according to the present disclosure may be sintered at 650 to 950°C, 750 to 950°C, or 800 to 900°C to form a ceramic substrate. In particular, the LTCC composition may be co-sintered at a low temperature with an electrode.

An Ag electrode may be used as the electrode, and a sintering time is 1 hour to 3 hours, which may be in an atmospheric atmosphere or an inert atmosphere. When an Al electrode is used, sintering is performed for 1 hour to 2 hours, which may be in the inert atmosphere.

Hereinafter, a manufacturing method of a ceramic electric element using an LTCC composition according to the present disclosure and a ceramic electric element obtained therefrom will be described.

The “ceramic electric element” in the present disclosure may be referred to as a ceramic electric component, a ceramic electronic component, a ceramic electric and electronic component, a ceramic electronic element, or a ceramic electric and electronic element, and includes a ceramic substrate and an electrode. The electrode may be made of a metal material and is formed on at least one surface of the ceramic substrate.

The ‘ceramic electric element’ may be a communication element used particularly in an ultra-high frequency band of approximately 15 GHz. The ultra-high frequency may be 1 to 30 GHz, and may also be millimeter waves and Sub-THz. Specifically, the ‘ceramic electric element’ may be a filter, an antenna, a sensor, an RF module, a capacitor, a resonator, or the like.

The ‘ceramic electric element’ may also be expressed as an electrical and electronic substrate or an LTCC substrate, and may also be expressed as an LTCC laminate, an LTCC element, an LTCC component, or the like.

The manufacturing method of the ceramic electric element is as follows.

A green tape is formed from a slurry of the LTCC composition, a metal electrode is disposed on at least one surface of the green tape, and the green tape and the metal electrode are co-sintered at 650 to 950°C.

The co-sintering has advantages of high process yield and device integration density, and an easy manufacturing method by heat-treating a ceramic green sheet with a printed electrode at one time, compared with a conventional hybrid integrated circuit process in which the ceramic substrate is first sintered, and then each electrode is printed thereon and further heat-treated.

Here, the green tape may be formed of multiple layers.

By the co-sintering at a low temperature of 650 to 950°C, the LTCC composition is converted into the ceramic substrate.

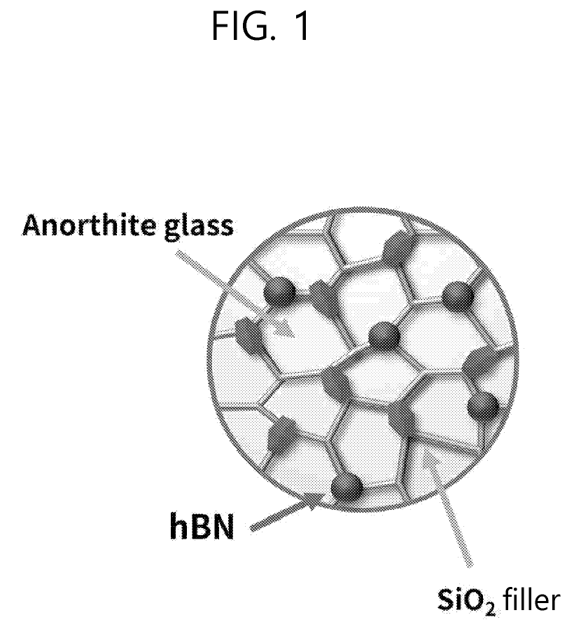

A surface configuration of the ceramic substrate is as illustrated in FIG. 1, and the anorthite phase may be obtained even when silica instead of alumina is used as the first filler.

A ratio of the anorthite phase in the ceramic substrate may be 70 to 100 wt%, 80 to 100 wt%, 90 to 100 wt%, 95 to 100 wt%, or 99 to 100 wt%.

In particular, the ceramic substrate may also include a diopside phase, and in this case, the ratio of the anorthite phase in the ceramic substrate may be 60 to 90 wt%, 70 to 90 wt%, or 80 to 100 wt%. The remainder is the diopside phase.

When silica, alumina, calcium oxide, and boron trioxide are used as frit components, an anorthite phase of 95 wt% or more may be obtained. When MgO is used as the frit component, the ratio of the anorthite phase may be 60 to 90 wt% or 60 to 80 wt%.

The dielectric constant of the obtained ceramic substrate at 15 GHz may be 3.75 to 4.05 or 3.85 to 4.05, the strength may be 235 to 265 MPa or 240 to 260 MPa, and the thermal conductivity may be 1.3 to 2.1 W/mK or 1.4 to 1.6 W/mK.

The ceramic electric element developed through the present disclosure simultaneously implements a low dielectric constant of the SiO₂ filler, high strength characteristics due to the anorthite crystalline phase, and high thermal dissipation characteristics through the hBN filler, enabling stable signal transmission even in the ultra-high frequency band and ensuring long-term substrate reliability. In addition, the ceramic electric element has electrical characteristics and thermal durability suitable for ultra-high-speed data transmission and high-density packaging required in a 6G communication environment, and may also contribute greatly to maintaining the lifespan and performance of the element by suppressing heat generation in the communication module.

Hereinafter, the present disclosure will be described in more detail with reference to Experimental Examples below.

Example 1: Frit (high content alumina) + first filler (silica)

A frit composition of 45 wt% SiO₂, 35 wt% Al₂O₃, 10 wt% CaO and 10 wt% B₂O₃ was melted at 1300°C to manufacture a frit (glass). Then, silica (first filler) and the frit were mixed while changing the volume ratio and sintered at 900°C.

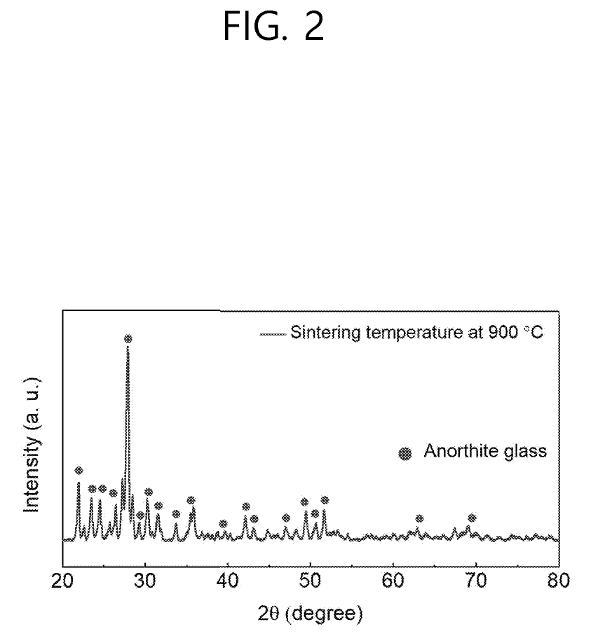

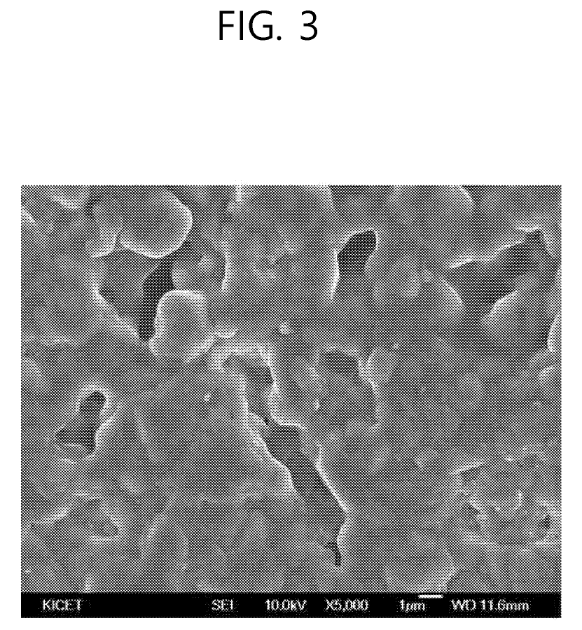

FIG. 2 is an XRD graph when the first filler is included in 30 vol % and FIG. 3 is an SEM image when the first filler is included in 30 vol %. It can be confirmed that an anorthite phase is formed by using alumina in an excess amount in the frit composition and using silica as the first filler.

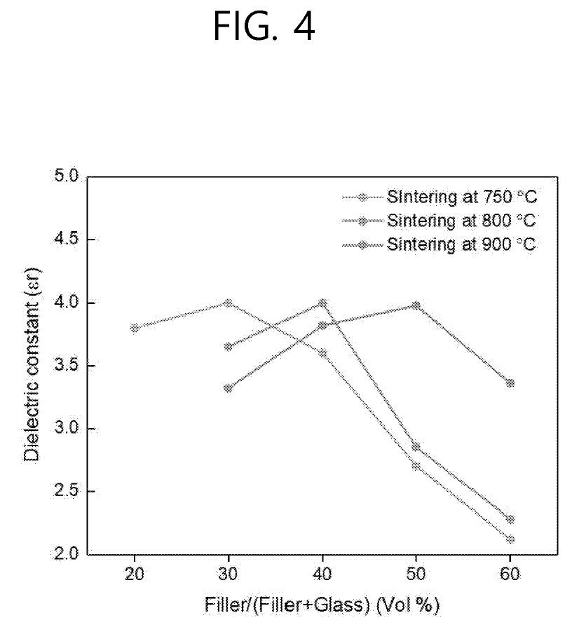

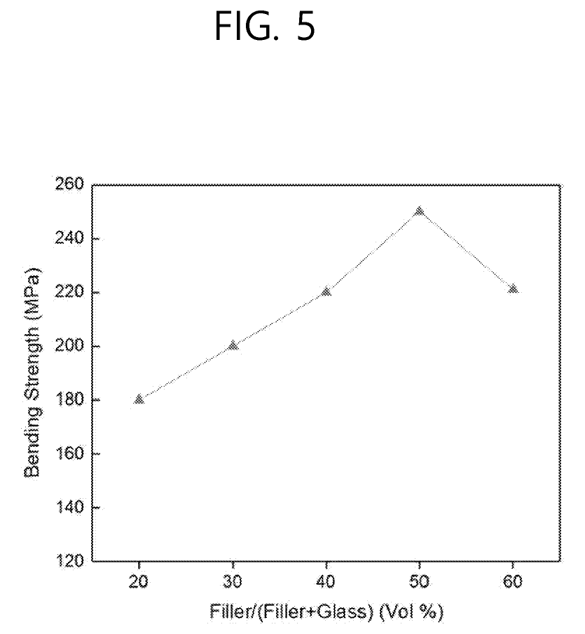

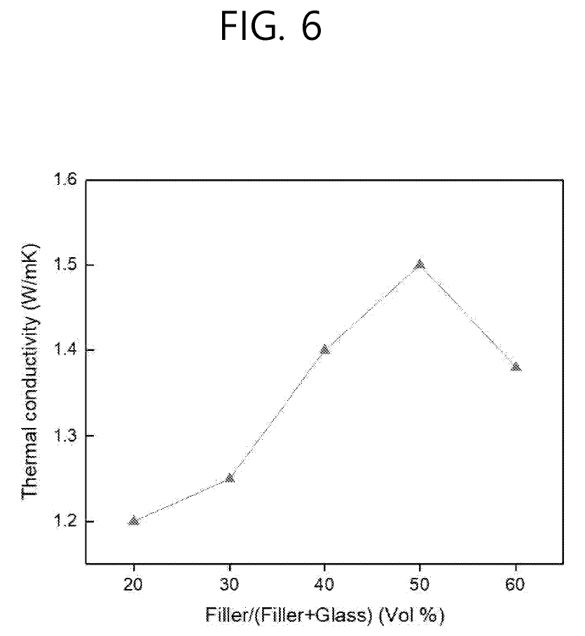

FIGS. 4 to 6 illustrate results of evaluating a dielectric constant (15 GHz), strength, and thermal conductivity while changing a volume ratio. The dielectric constant was evaluated while changing a sintering temperature to 750°C, 800°C, and 900°C.

It can be confirmed that the strength and the thermal conductivity decrease when the first filler exceeds 50 vol %. When the first filler was included in 50 vol %, a dielectric constant of 4.00 or less and a strength of 250 MPa or more could be obtained. When the first filler was included in 50 vol %, the first filler content was 45 wt% and the frit content was 55 wt%.

Comparative Example 1: Frit (low content alumina) + first filler (alumina)

A frit composition of 50 wt% SiO₂, 15 wt% Al₂O₃, 25 wt% CaO and 10 wt% B₂O₃ was melted at 1300°C to manufacture a frit (glass). Then, alumina (first filler) and the frit were mixed while changing the volume ratio and sintered at 900°C.

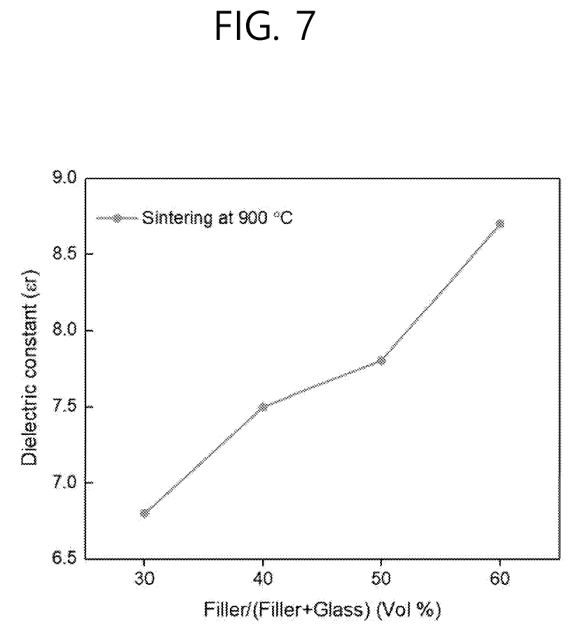

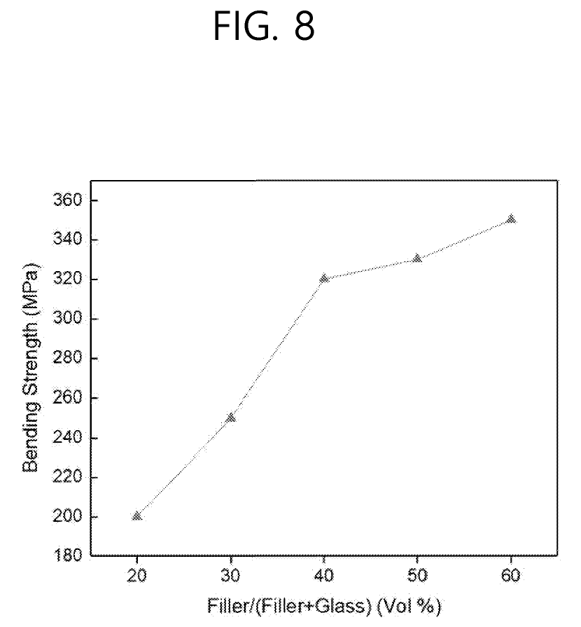

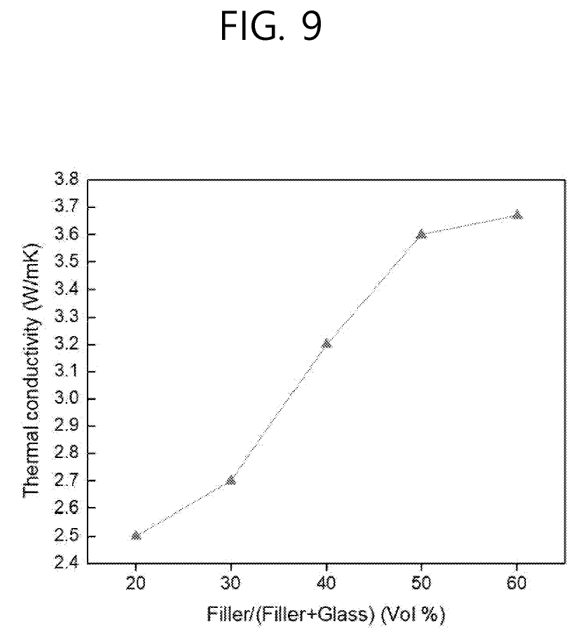

FIGS. 7 to 9 illustrate results of evaluating a dielectric constant (15 GHz), strength, and thermal conductivity while changing a volume ratio.

Although the strength and the thermal conductivity are high by using the alumina filler, the dielectric constant is too high, resulting in very large signal loss when used for an ultra-high frequency band communication substrate.

Comparative Example 2: Frit (high content alumina) + first filler (alumina)

The frit of Example 1 and the alumina were mixed while changing a volume ratio, and then sintered at 900°C.

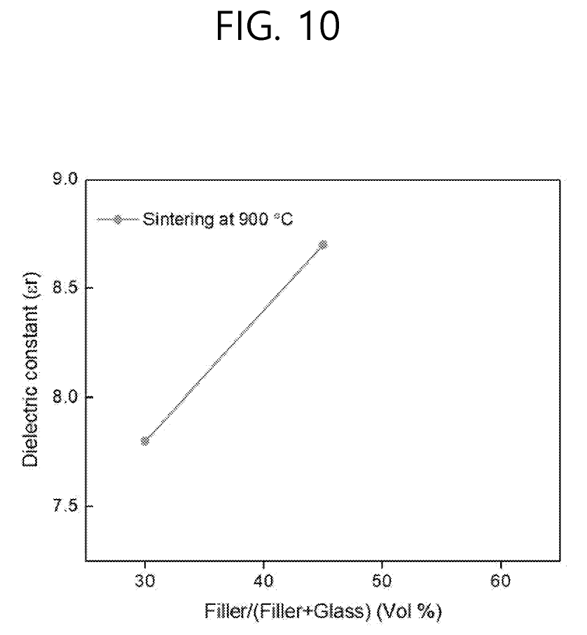

As illustrated in FIG. 10, the dielectric constant was extremely high, and particularly, when the alumina filler content exceeded 50 vol %, sintering was difficult and the dielectric constant was difficult to measure.

Example 2: Frit + first filler + second filler

In a state in which the frit and the first filler of Example 1 were in a volume% of approximately 50:50, hBN was added as the second filler, followed by sintering at 900°C.

The second filler was 100% hBN and was manufactured by the following method.

Boric acid (H₃BO₃), melamine (C₃H₆N₆) and a dispersant were injected into distilled water, and stirred and reacted. The dispersant, darvan-c was used in an amount of 1 wt% or more, and the mixture was stirred at a temperature condition of 80°C for 24 hours or more to sufficiently disperse boric acid and melamine ions in a solution.

A binder was injected into the stirred reaction solution, and additionally stirred. PVA was used as the binder. The additional stirring was carried out for 30 minutes or more under a temperature condition of 90°C.

The solution dispersed in water was spray-dried by an ultrasonic method to manufacture preliminary particles, and the preliminary particles were sintered under a temperature condition of 1500°C or higher to manufacture secondary particles. A particle size distribution was 1 to 10 μm, and D50 was 3 μm.

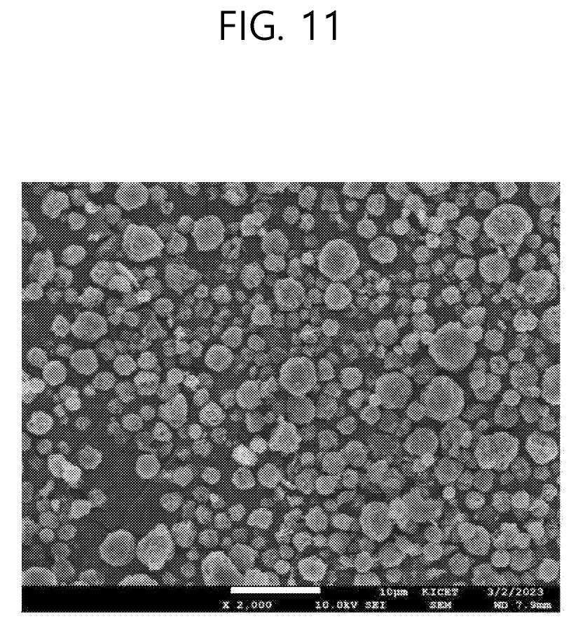

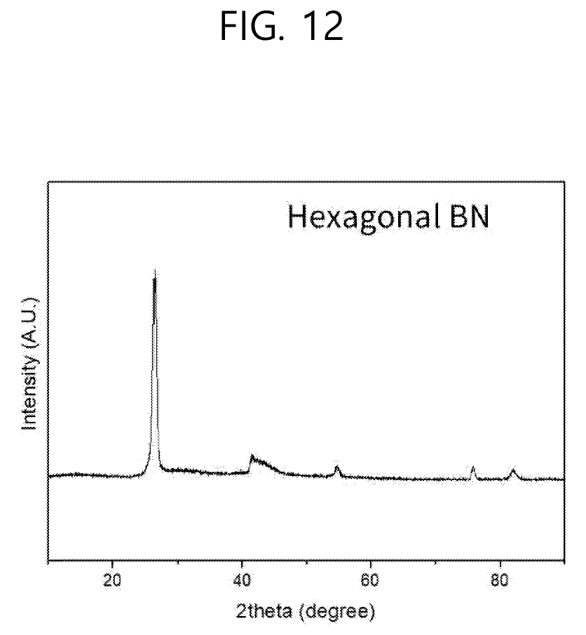

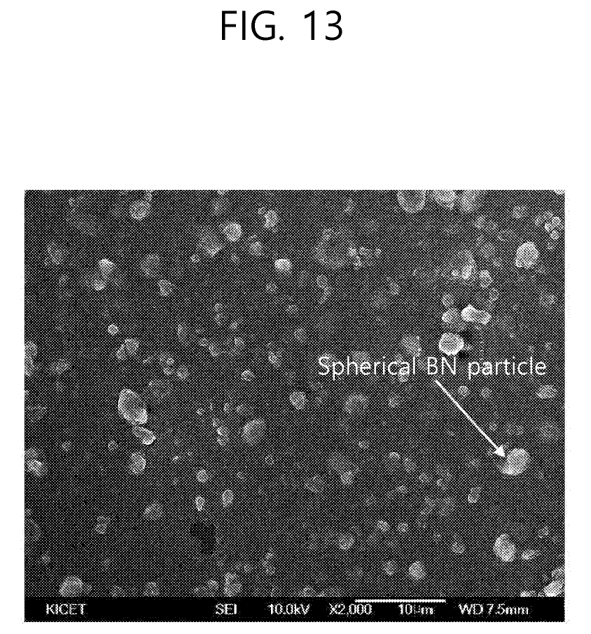

The hBN had a spherical shape with an average size of 3 μm. FIGS. 11 and 12 are an SEM image and an XRD graph of the hBN, and FIG. 13 is an SEM image when 10 vol % of the hBN is used.

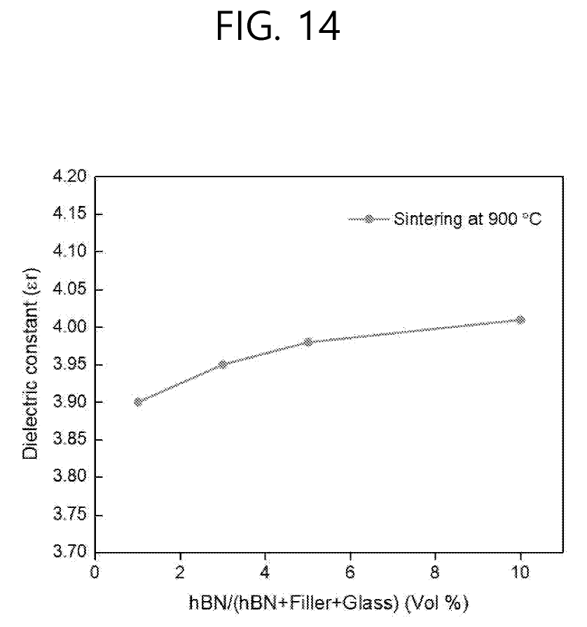

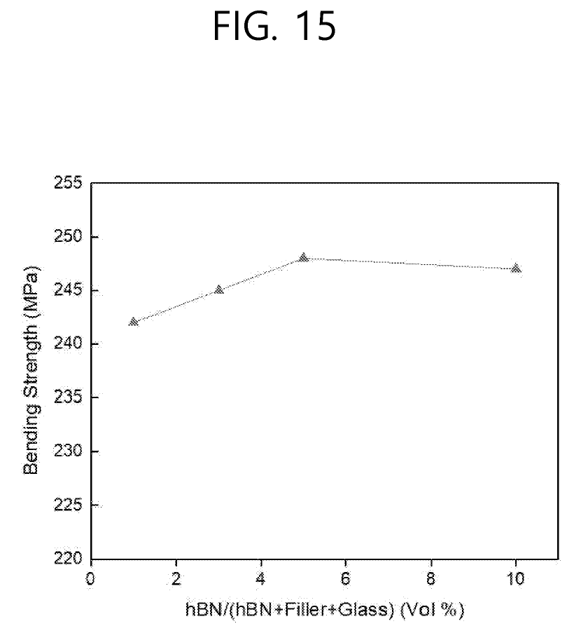

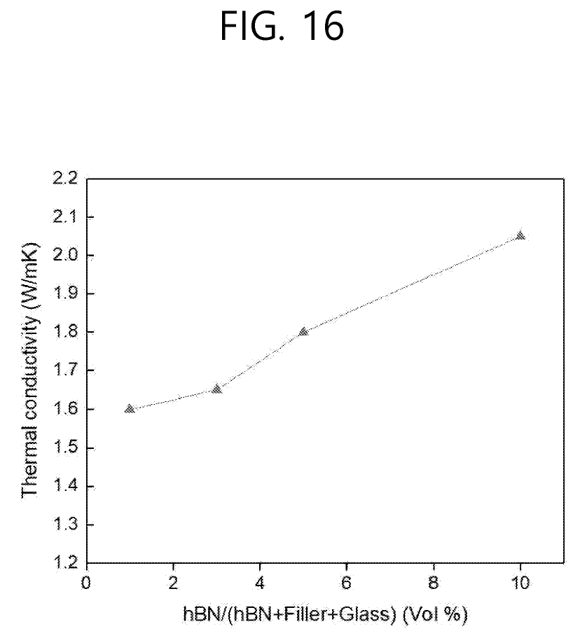

FIGS. 14, 15, and FIG. 16 illustrate results of evaluating a dielectric constant (15 GHz), strength, and thermal conductivity while changing a use amount of hBN. The dielectric constant was evaluated while changing a sintering temperature to 750°C, 800°C, and 900°C.

When the second filler was 10 vol %, a dielectric constant of 4.01, a strength of 248 MPa, and thermal conductivity of 2.00 W/mK could be obtained. When the second filler was 10 vol %, the first filler content was 41 wt%, the frit content was 50 wt%, and the second filler content was 9 wt%.

Comparative Example 3: Frit + first filler + second filler (planar hBN)

In a state in which the frit and the first filler of Example 1 were in a volume% of approximately 50:50, the planar hBN was added as the second filler, followed by sintering at 900°C. Planar hBN was a product of US Research Nanomaterials. A purity was 99.8%, and a size was 70 to 80 nm.

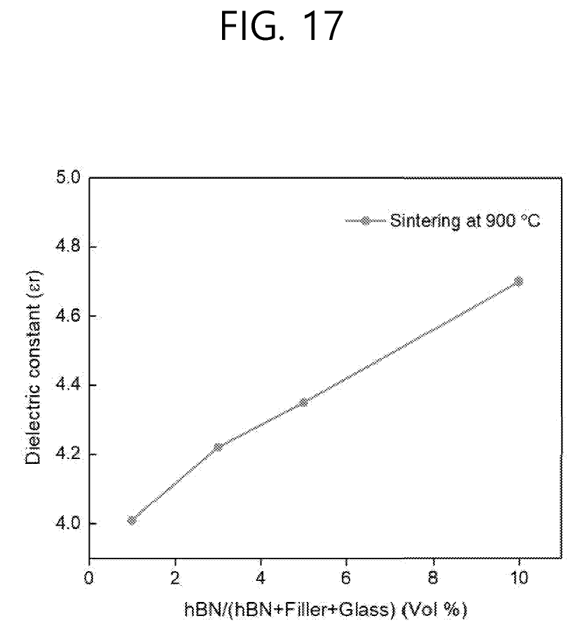

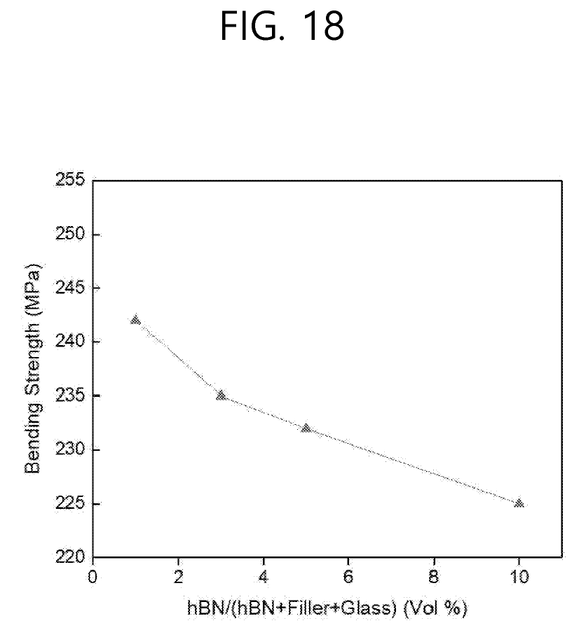

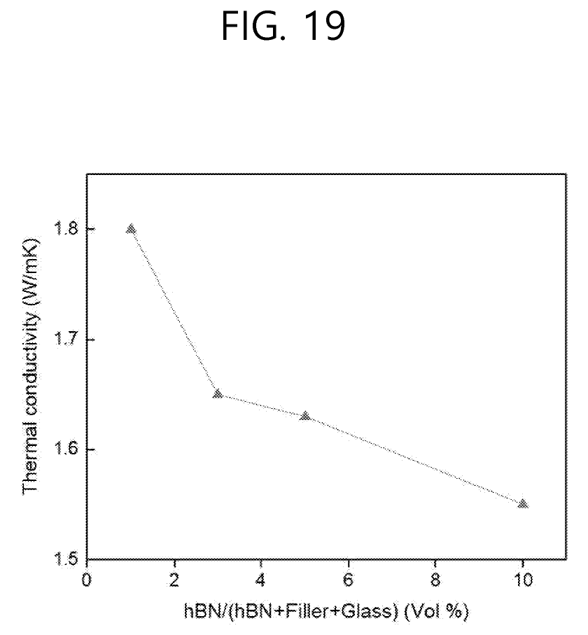

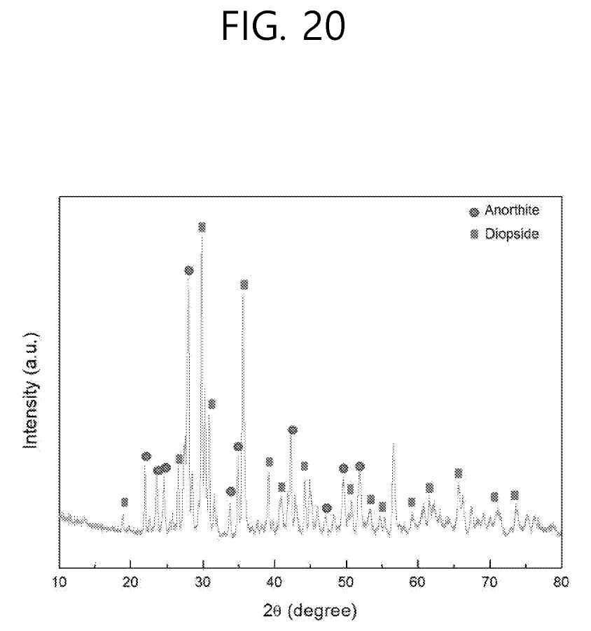

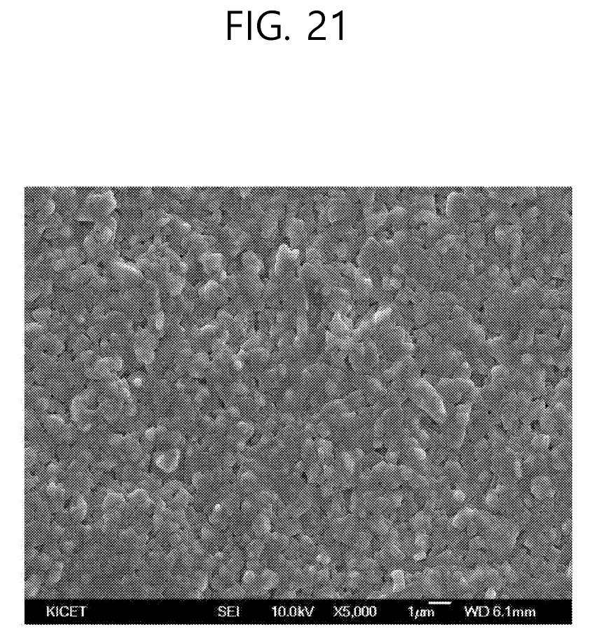

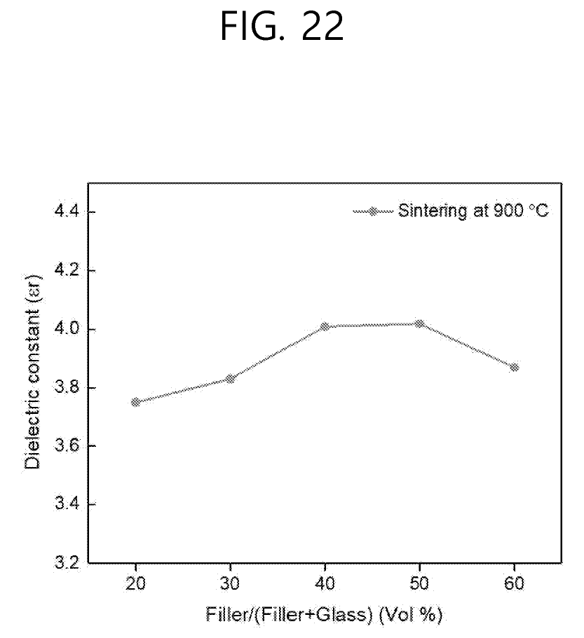

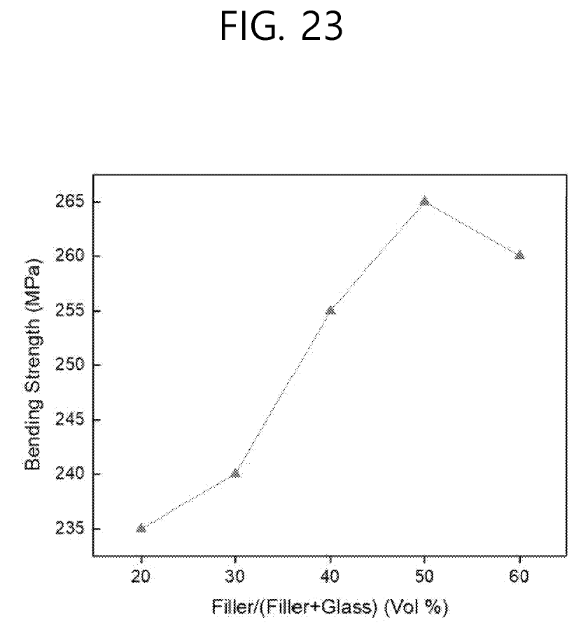

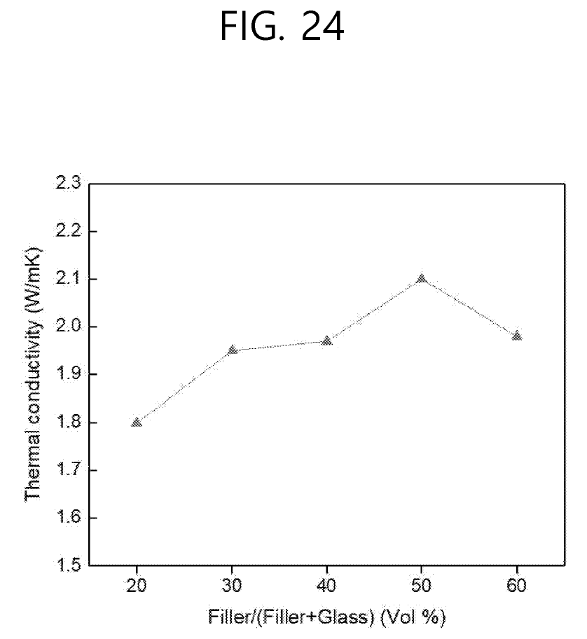

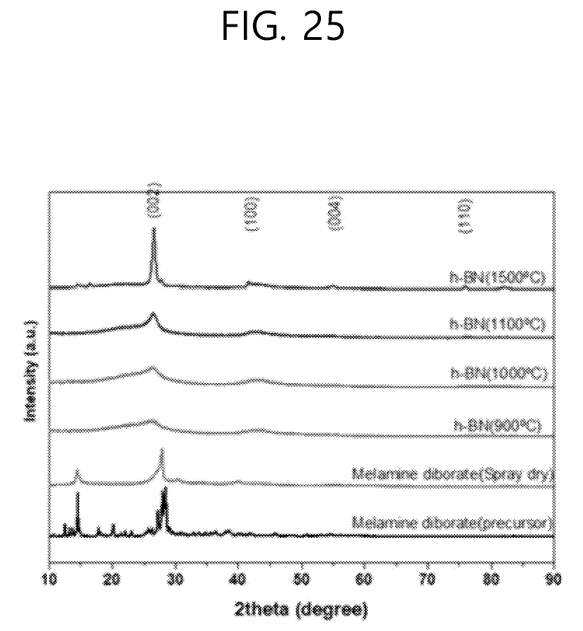

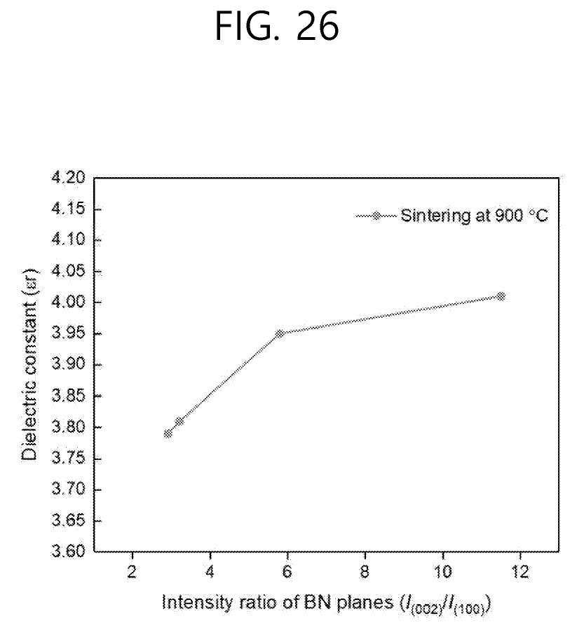

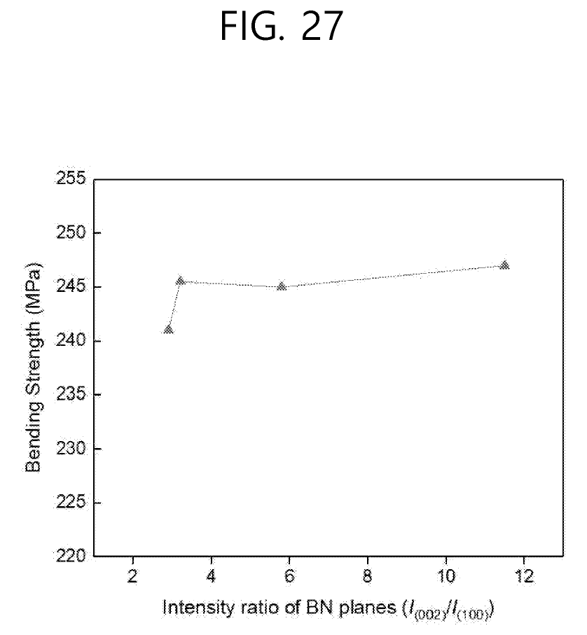

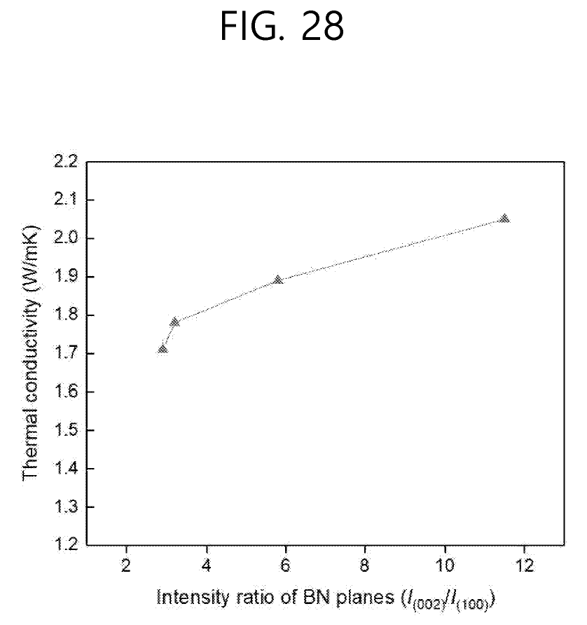

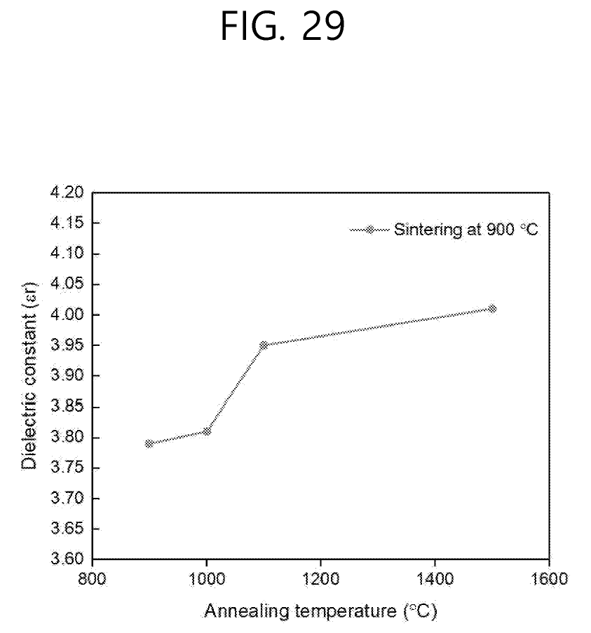

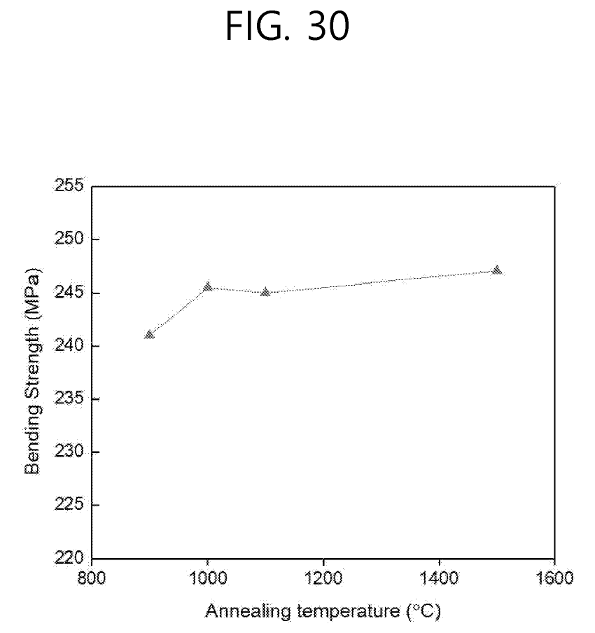

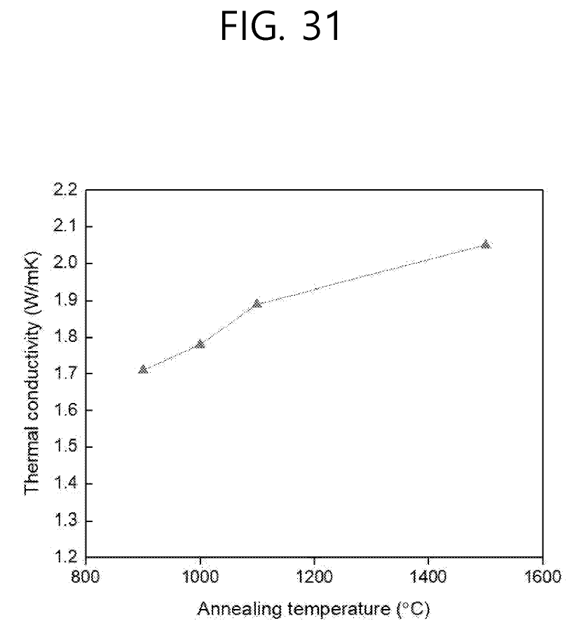

FIGS. 17, 18, and 19 illustrate results of evaluating a dielectric constant (15 GHz), strength, and thermal conductivity while changing a use amount of planar hBN.

When the second filler was 10 vol %, a dielectric constant of 4.75, a strength of 225 MPa, and thermal conductivity of 1.55 W/mK could be obtained. . In the case of the planar hBN, a slurry dispersion state was vulnerable, resulting in a decrease in strength and thermal conductivity and an increase in dielectric constant.

Example 3: Frit + first filler + second filler - Including diopside-based frit

In Examples 1 and 2, the composition of the frit was 45 wt% SiO₂, 32 wt% Al₂O₃, 10 wt% CaO, 8 wt% B₂O₃, and 5 wt% MgO. Here, MgO served to form a diopside phase.

FIG. 20 is an XRD graph after sintering a frit and a first filler (silica) when 50 vol % of the first filler is used as in Example 1 and FIG. 21 is an SEM image when the volume ratio of the first filler and the frit is approximately 50:50 and 10 vol % of granular h-BN is used as in Example 2.

A mass ratio of the anorthite phase to the diopside phase was approximately 3:1.

FIGS. 22, 23, and FIG. 24 illustrate results of evaluating a dielectric constant (15 GHz), strength, and thermal conductivity while fixing the use amount of hBN to 10 vol % and changing a use amount of the first filler.

When the volume ratio of the first filler and the frit was 50:50, a dielectric constant of 4.02, a strength of 265 MPa, and thermal conductivity of 2.10 W/mK could be obtained.

Example 4: Manufacturing of second filler containing amorphous phase

Boric acid (H₃BO₃), melamine (C₃H₆N₆) and a dispersant were injected into distilled water, and stirred and reacted. In a ratio of boric acid:melamine, an excess amount of boric acid of 7:1 was used.

Added concentrations of boric acid and melamine were 0.07 M and 0.01 M, respectively. The amount of the dispersant was 1 wt%, and darvan-c was used as the dispersant.

Stirring was performed at 80°C for 24 hours to sufficiently disperse boric acid and melamine ions in the solution. A binder was injected into the stirred reaction solution, and additionally stirred.

PVA was used as the binder. Additional stirring was performed at 90°C for 1 hour. In the additional stirring, an ultrasonic disperser, an emulsifier, or the like may be further applied for dispersion.

The solution dispersed in water was spray-dried to implement spherical particles. For implementing the spherical particles, the size of droplets may be controlled to 10 μm or less, or 3 μm or less by an ultrasonic method or a fine spray method. The spherical particles have a size of approximately 1 to 2 μm based on D50.

The spherical particles were heat-treated in a nitrogen atmosphere at various temperature conditions for 2 hours or longer.

FIG. 25 illustrates an XRD graph according to a heat treatment temperature. Depending on a temperature condition, a melamine diborate peak disappeared and amorphous BN was observed, and a hexagonal BN phase was observed at a higher temperature.

Example 5: Frit + first filler + second filler (including amorphous phase)

In a state in which the frit and the first filler (silica) of Example 1 were in a volume% of approximately 50:50, a spherical second filler including hexagonal BN and amorphous BN was used. The sintering temperature was 900°C.

The use amount of the second filler was fixed at 10 vol %, and the content of the amorphous BN was changed by changing the heat treatment temperature during a manufacturing process of the second filler.

FIGS. 26 to 28 illustrate changes in dielectric constant, strength and thermal conductivity according to an intensity ratio of I₍₀₀₂₎/I₍₁₀₀₎ in the XRD graph and FIGS. 29 to 31 illustrate changes in dielectric constant, strength and thermal conductivity according to a heat treatment temperature in a second filler manufacturing process. As the treatment temperature increases, the intensity ratio increases, which means that the hBN content increases. It can be seen that a dielectric constant of 3.81, a strength of 245 MPa, and thermal conductivity of 1.80 W/mK may be achieved in a 15 GHz band.

Effects of the present disclosure described above are as follows.

Commercial high strength LTCC has a structure in which anorthite crystalline glass powder and an alumina filler are composited. Such a structure is a structure in which the alumina filler is composited in an anorthite crystalline glass matrix by a mechanism in which anorthite nucleation is generated from a surface of the alumina filler during sintering and gradually grows. In this case, strength characteristics are very high at 300 to 400 MPa due to the anorthite crystalline phase + alumina filler, but introduction of the alumina filler increases both the dielectric constant (7 to 8) and dielectric loss (0.01 to 0.6 @ 15 GHz), which causes significant signal loss and signal attenuation at an ultra-high frequency.

Raw materials such as SiO₂, CaO, Al₂O₃, etc., are used in manufacturing anorthite crystalline glass. In the present disclosure, glass powder is manufactured by increasing an Al₂O₃ raw material ratio for anorthite formation, and then a low dielectric filler such as silica is composited. In this case, similar to an existing nucleation mechanism, nucleation and growth of crystalline glass occur from the surface of the low dielectric filler during sintering and in this case, since a glass composition itself has a high alumina raw material content, an anorthite crystalline glass phase exhibiting high strength characteristics may be formed. In the frit composition of the present disclosure, a high strength glass matrix crystal structure forms anorthite while applying various low dielectric fillers, which is very advantageous in terms of dielectric constant control.

Existing low dielectric LTCC materials have a low dielectric constant of 3.9 but very weak strength (125 MPa). For high strength LTCC materials, the strength is very high, ranging from 300 MPa to 400 MPa, but the dielectric constant is very high, ranging from 7 to 8, which is not suitable for Ka/E-band ultra-high frequency communication substrates. Therefore, there is a need for an LTCC material composition that simultaneously ensures strength characteristics and dielectric characteristics.

In implementation of the anorthite crystal according to the present disclosure, when the filler is a SiO₂ filler with a dielectric constant of 3 to 4 to form the anorthite, low dielectric characteristics and high strength characteristics may be ensured in the 15 GHz ultra-high frequency band. This can reduce a signal delay effect and prevent damage caused by thermal stress in 6G communication due to the use of Ka/E-band millimeter waves, which are higher than those in existing 5G.

In 6G communication, ultra-high frequency heat generation due to the use of Ka-/E-band millimeter waves higher than the existing 5G and local heat generation due to miniaturization and high integration of antennas occur simultaneously, concentrating thermal stress and causing substrate cracking, but substrates for millimeter wave band communication generally have a dielectric constant as low as approximately 4, but thermal conductivity is low at 1.7 W/mK and a strength is approximately 125 MPa, which are vulnerable to thermal stress.

Hexagonal boron nitride (hBN) is a two-dimensional material that exhibits high thermal conductivity characteristics of around 600 W/mK in an in-plane direction, but exhibits anisotropic characteristics of around 30 W/mK in an out-of-plane direction (thickness direction). Furthermore, due to its two-dimensional flake structure, there is a disadvantage in that low slurry dispersion characteristics for manufacturing LTCC green sheets, resulting in reduced sintering density of a final sintered body and thus decreased thermal conductivity.

In the present disclosure, a second filler containing the hBN is granulated (spheroidized) to maintain constant thermal conductivity characteristics regardless of directionality while enhancing slurry dispersion characteristics to increase the density of the sintered body, thereby obtaining high thermal conductivity.

The foregoing embodiments are examples for describing the present disclosure, and the present disclosure is not limited thereto. Those skilled in the art to which the present disclosure pertains will be able to practice the present disclosure with various modifications therefrom, and the technical protection scope of the present disclosure shall be defined by the appended claims.

What is claimed is:

1. An LTCC composition having an improved property, comprising:
a frit including silica and alumina;
a first filler including at least any one of silica and alumina; and
a second filler including hexagonal boron nitride and having a granular shape.

2. The LTCC composition of claim 1, wherein the first filler includes silica, and
the first filler content is 100 to 140 parts by weight and the second filler content is 15 to 30 parts by weight, with respect to 100 parts by weight of the frit.

3. The LTCC composition of claim 2, wherein the first filler includes silica, and
wherein the first filler content is 110 to 130 parts by weight and the second filler content is 18 to 25 parts by weight, with respect to 100 parts by weight of the frit.

4. The LTCC composition of claim 2, wherein a sintering temperature of the LTCC composition is 650 to 950°C.

5. The LTCC composition of claim 4, wherein the LTCC composition has a dielectric constant of 3.75 to 4.05, a strength of 235 to 265 MPa, and a thermal conductivity of 1.3 to 2.1 W/mK at 15 GHz after sintering.

6. The LTCC composition of claim 4, wherein a particle size distribution of the second filler is 1 to 10 μm, and
wherein D50 is 2 to 4 μm.

7. The LTCC composition of claim 4, wherein the second filler further includes amorphous boron nitride, and
wherein an intensity ratio of I₍₀₀₂₎/I₍₁₀₀₎ of the second filler is 2 to 7 in an XRD graph.

8. The LTCC composition of claim 4, wherein the alumina content in the frit is 30 to 40 wt%.

9. The LTCC composition of claim 8, wherein the frit further includes calcium oxide and boron trioxide, and with respect to 100 parts by weight of the silica, the alumina content is 65 to 90 parts by weight, the calcium oxide content is 15 to 30 parts by weight, and the boron trioxide content is 15 to 30 parts by weight.

10. A manufacturing method of a ceramic electric element using low-temperature co-sintering, comprising:
forming a green tape from a slurry of an LTCC composition;
disposing a metal electrode on at least one surface of the green tape; and
co-sintering the green tape and the metal electrode at 650 to 950°C,
wherein the LTCC composition includes
a frit including silica and alumina;
a first filler including at least one of silica and alumina; and
a second filler including hexagonal boron nitride and having a granular shape.

11. The manufacturing method of claim 10, wherein the first filler includes silica, and
wherein the first filler content is 100 to 140 parts by weight and the second filler content is 15 to 30 parts by weight, with respect to 100 parts by weight of the frit.

12. The manufacturing method of claim 11, wherein the LTCC composition has a dielectric constant of 3.75 to 4.05, a strength of 235 to 265 MPa, and a thermal conductivity of 1.3 to 2.1 W/mK at 15 GHz after sintering.

13. The manufacturing method of claim 12, wherein a particle size distribution of the second filler is 1 to 10 μm, and
wherein D50 is 2 to 4 μm.

14. The manufacturing method of claim 12, wherein the alumina content in the frit is 30 to 40 wt%.

15. A ceramic electric element obtained through low-temperature co-sintering, comprising:
a ceramic substrate; and
a metal electrode formed on at least one surface of the ceramic substrate,
wherein the ceramic substrate includes a BN filler that includes hexagonal boron nitride and has a granular shape.

16. The ceramic electric element of claim 15, wherein the BN filler content is 5 to 13 wt% in the ceramic substrate.

17. The ceramic electric element of claim 15, wherein the ceramic substrate has a dielectric constant of 3.75 to 4.05, and strength of 235 to 265 MPa, and a thermal conductivity of 1.3 to 2.1 W/mK at 15 GHz.

18. The ceramic electric element of claim 16, wherein a particle size distribution of the BN filler is 1 to 10 μm, and
wherein D50 is 2 to 4 μm.

19. The ceramic electric element of claim 17, wherein the BN filler further includes amorphous boron nitride, and
wherein an intensity ratio of I₍₀₀₂₎/I₍₁₀₀₎ of the BN filler is 2 to 7 in an XRD graph.

20. The ceramic electric element of claim 17, wherein a crystalline phase of the ceramic substrate contains 80 to 100 wt% of an anorthite phase, and
wherein the ceramic substrate and the metal electrode are obtained by co-sintering at 650 to 950°C.
